(19) United States
(12) Patent Application Publication
(10) Pub. No.: US 2016/0189069 A1
(43) Pub. Date: Jun. 30, 2016

(54) CREATING PRE-ORDER CATALOGS BASED ON REAL-TIME INVENTORIES AND CARRIER-RELATED DATA

(71) Applicant: e-gatematrix, llc, Reston, VA (US)

(72) Inventors: Simon James de Montfort Walker, Winnetka, IL (US); Sreenivas Divi, Ashburn, VA (US); Rodney Duane Duty, Marietta, GA (US); Keshav Vishveshvaraiah Kiran, Sterling, VA (US); Michael James Motherway, Chicago, IL (US)

(21) Appl. No.: 14/586,562

(22) Filed: Dec. 30, 2014

(51) Int. Cl. G06Q 10/06; G06Q 30/06; G06Q 50/14; G06Q 50/12; G06Q 10/02; G06Q 10/08

(52) U.S. Cl. CPC G06Q 10/06312; G06Q 10/02; G06Q 10/087; G06Q 50/14; G06Q 50/12; G06Q 30/0603

(57) ABSTRACT

A pre-order system allows a passenger to pre-order products from a dynamically generated product catalog based on real-time supply inventories at the departure location of the passenger's vehicle and to have those selected products be delivered to the passenger while the vehicle is in-transit. At the request of a passenger, the pre-order system determines, using the passenger's itinerary and other data of the passenger, the physical product supply inventories available at the departure location in real-time and available to be loaded onto the vehicle on which the passenger will depart. In response to a passenger selection, the pre-order system automatically generates a vehicle service order, a packing inventory list, and a loading plan for the passengers vehicle that are all used to ensure the pre-order products may be delivered to the passenger while in-transit.

### FIELD OF INVENTION

This disclosure generally relates to logistics of supplying carrier vehicles, and more specifically, to utilizing real-time supply inventory logistics to determine products available for delivery to passengers while in-transit and to dynamically generate an optimized vehicle service order, a packing inventory list, and a loading plan based on available weight and space used to load items on the carrier vehicle.

### BACKGROUND

Carriers, including airlines, train lines, bus lines, etc., have been long offering their passengers onboard meals and products. To determine the type and number of meals and products, a carrier is forced to predict or to estimate the type and the number of meals and products to load onto a vehicle (e.g., aircraft, train car, bus, cruise ship, ferry, etc.) before departure. If the carrier improperly forecasts the number and types of meals, the popular meals may quickly run out during the trip, resulting in the less popular meals being thrown out and wasted. Furthermore, if the carrier incorrectly predicts the sales of on-board products to be delivered in-transit, jet fuel is wasted moving unsold merchandise from one location to another.

More recently, carriers have been offering their passengers the option to pre-order meals, duty-free products, and other onboard products that are ordered prior to departure but delivered while in-transit. Commonly, these carriers allow passengers to pre-order products or services at the time the ticket is purchased, generally a point that occurs weeks or months in advance of the passenger's departure. Moreover, the carrier typically only allows the passenger to purchase pre-order meals and products through the carrier's ticket booking channels or through a carrier-approved or known vendor to which the carrier directs the passenger. However, the choices of meals and products offered are severely limited to the few choices offered by the airline and/or approved vendors because the food and supplies must be determined weeks or months out. These choices are generally identical to meals choices offered to passengers who did not pre-order a meal or product. At best, the carrier may attempt to use the information from any pre-ordered meals or products to predict the number and types of remaining meals for the passenger whom did not pre-order. Moreover, because vendors remove the leftover meals and products (and trash), the carrier is wholly unaware of the type and number of meals and products consumed by the passengers and the type and number of unconsumed, wasted meals.

Additionally, conventional pre-ordered meal and product systems are not integrated with carrier booking systems. For example, if a passenger pre-orders a product using a conventional pre-order system, the crew of the vehicle is required to perform the manual in-cabin process of identify the seat number of passenger by paper and delivering the ordered product to the passenger. This lack of integration between conventional pre-order systems and the booking systems leads to confusion, slower service, and more time to manually determine the correct recipient of the pre-order product.

### SUMMARY

A computer-implemented method for automatically generating, in real-time and based on a pre-order of products, a vehicle service order, an updated optimized vehicle service order, and a loading plan associated with a specific vehicle in which the vehicle service order includes at least a particular set of products to be loaded onto the specific vehicle before departure. The method also receives, via a digital communication network, a request for a passenger to pre-order one or more products before the departure of a specific vehicle in which the passenger is scheduled to depart on the specific vehicle, the one or more products are to be delivered in-transit to the passenger after the departure of the specific vehicle, and the passenger is associated with passenger itinerary data that includes at least a departure location of the specific vehicle. The method determines using the passenger itinerary data, products available for in-transit delivery cased on a real-time supply inventory of items physically available at the departure location associated with the passenger itinerary data in which the supply inventory including items supplied by one or more suppliers. The method further transmits, via the digital communication network, the determined products available for in-transit delivery on the specific vehicle and receives a selection of one or more desired products to be delivered in-transit to the passenger after departure of the specific vehicle in which the selection of the one or more desired products being, a subset of the available products. The method generates, in real-time and using the received selection of the one or more desired products, an optimized vehicle service order for the specific vehicle that includes at least the selection of the received selection of the one or more desired products.

In another embodiment, a computer readable medium having instructions stored thereon and executable by one or more processors, performs a method of automatically generating, in real-time and based on a pre-order of products, an updated vehicle service order associated with a specific vehicle in which the vehicle service order includes at least a particular set of products to be loaded onto the specific vehicle before departure. The method also receives, via a digital communication network, a request for a passenger to pre-order one or more products before the departure of a specific vehicle in which the passenger is scheduled to depart on the specific vehicle, the one or more products are to be delivered in-transit to the passenger after the departure of the specific vehicle, and the passenger is associated with passenger itinerary data that includes at least a departure location of the specific vehicle. The method determines using the passenger itinerary data, products available for in-transit delivery based on a real-time supply inventory of items physically available at the departure location associated with the passenger itinerary data in which the supply inventory including items supplied by one or more suppliers. The method further transmits, via the digital communication network, the determined products available for in-transit delivery on the specific vehicle and receives a selection of one or more desired products to be delivered in-transit to the passenger after departure of the specific vehicle in which the selection of the one or more desired products being a subset of the available products. The method generates, in real-time and using the received selection of the one or more desired products, an updated vehicle service order for the specific vehicle that includes at least the selection of the received selection of the one or more desired products.

In yet another embodiment, a system for automatically generating, in real-time and based on a pre-order of products, an updated vehicle service order associated with a specific vehicle in which the vehicle service order includes at least a particular sot of products to be loaded onto the specific vehicle before departure includes a pre-order engine. The pre-order engine is configured to receive, via a digital communication network, a request for a passenger to pre-order one or more products before the departure of a specific vehicle in which the passenger is scheduled to depart on the specific vehicle, the one or more products are to he delivered in-transit to the passenger after the departure of the specific vehicle, and the passenger is associated with passenger itinerary data that includes at least a departure location of the specific vehicle. The pre-order engine is further configured to determine using the passenger itinerary data, products available for in-transit delivery based on a real-time supply inventory of items physically available at the departure location associated with the passenger itinerary data in which the supply inventory including items supplied by one or more suppliers. The pre-order engine is configured to transmit, via the digital communication network, the determined products available for in-transit delivery on the specific vehicle and receive a selection of one or more desired products to be delivered in-transit to the passenger after departure of the specific vehicle in which the selection of the one or more desired products being a subset of the available products. Additionally, the pre-order engine is configured to generate, in real-time and using the received selection of the one or more desired products, an updated vehicle service order for the specific vehicle that includes at least the selection of the received selection of the one or more desired products.

### BRIEF DESCRIPTION OF THE DRAWINGS

FIG. 1 is a high-level block diagram of a computing environment that implements a pre-order system that allows a passenger to pre-order, in real-time, products to be delivered while the passenger is in-transit on a vehicle;

FIG. 2 illustrates an example routine or process flow diagram for determining available products to be delivered in-transit, accepting a pre-order selection from a passenger, and generating an updated vehicle service order, a packing inventory list, and a loading plan to reflect the passenger's pre-order selection;

FIG. 3 illustrates an example routine or process flow diagram for identifying a passenger's pre-order selection associated with a data change in carrier database and for sending an notification to the passenger.

### DETAILED DESCRIPTION

Generally speaking, a pre-order system allows a passenger to pre-order products from a dynamically generated product catalog based on real-time supply inventories at the departure location of the passenger's vehicle and to have those selected products be delivered to the passenger while the vehicle is in-transit. To create is pre-order for a passenger, the pre-order system receives a request from a passenger whom desires to order or to select one or more products to be delivered while the passenger is in-transit on an upcoming trip on a vehicle of a carrier. The pre-order system determines, using the passenger's itinerary and other data of the passenger, the physical product supply inventories available at the departure location in real-time and available to be loaded onto the vehicle on which the passenger will depart. The pre-order system displays the available products to be delivered while in-transit to the passenger, and in response, the passenger may specify a selection of one or more products. The pre-order system determines the items, ingredients, dishware, containers, etc. required to fulfill the order of the one or more products and automatically updates a bill of materials. This bill of materials may include an optimized vehicle service order, a packing inventory list, and a loading plan based on the vehicle specifications (e.g. available weight and space) for the vehicle accordingly. The automatically generated vehicle service order is provided to a vendor (e.g., a caterer) that may prepare pre-ordered (and non-pre-ordered) meals to load on the vehicle, for example. The packing inventory list may be automatically updated, as described above, to instruct the manner in which food, products, etc. are loaded into containers, carts, etc. each time a passenger desires to pre-order products or to change their already placed pre-order. The loading plan may be automatically generated to instruct the vendor (or a different loading crew) how to optimally stow the products in the galley of the vehicle. Moreover, the pre-order system may continually update, the vehicle service order, the inventory packing list, and the loading plan up until the point when the caterer must pack supplies to load the vehicle. Significantly, the pre-order system not only streamlines the entire pre-order process but allows passengers to select more varied onboard products, meals, etc. very shortly before their departure.

Advantageously, this configuration of the pre-order system allows for the effective management of supplying goods and products from a warehouse to a passenger, including any intermediate steps in preparation, packaging. etc. As a result, a passenger's first choice of a meal is always available, for example, and the crew is less likely to exhaust that type of meal while in-transit. Furthermore, because the pre-order system is able to lock in that passenger's meal preference before the flight, the need to predict that passenger's meal preference is eliminated. In other words, the pre-order system removes the guesswork in determining the numbers for different types of meals for a trip, for example, and minimizes waste in lowering or eliminating the number of uneaten meals required to be thrown out. Moreover, the pre-order system allows for just-in-time capabilities that improve performance, operations, and onboard economics while enhancing customer service. Because the flexible configuration of the pre-order system does not require suppliers to be pre-determined, a central marketplace for suppliers may be implemented so that multiple supplier may even compete on a vehicle by vehicle basis. Furthermore, the pre-order system beneficially allows for carriers, suppliers, vendors, caterers, etc. to seamlessly communicate demand-based supply information across the supply chain. For example, carriers may “upstream” source raw materials from suppliers on-demand and may “downstream” billing and reconciliation information to a location-specific vendor, supplier, caterer, etc.

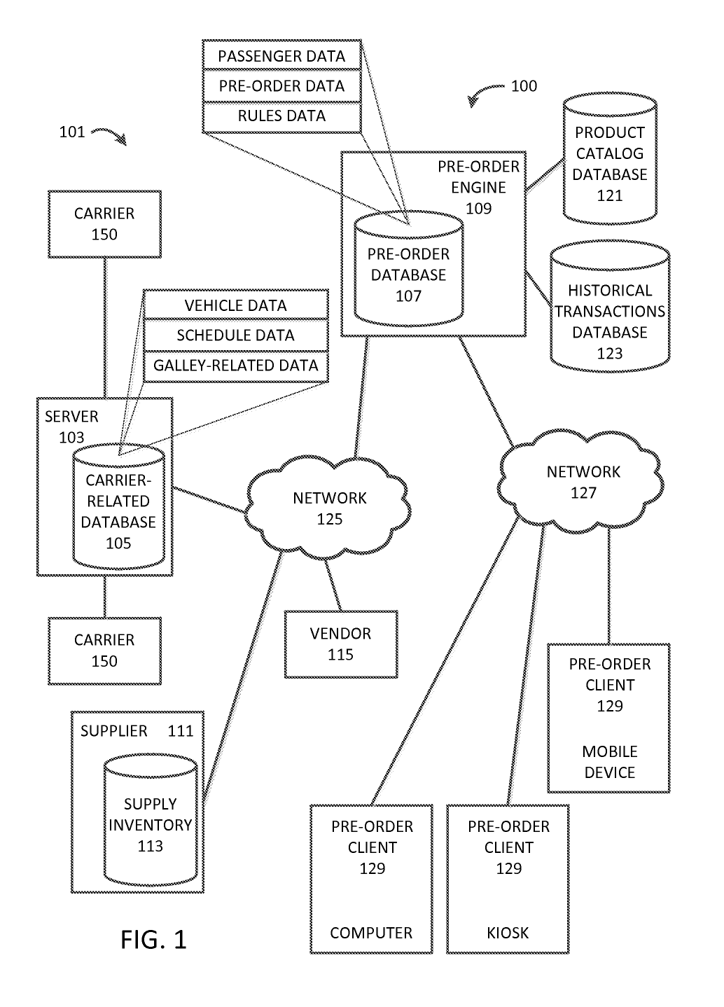

FIG. 1 is a high-level block diagram that illustrates a computing environment for a pre-order system 100 and a carrier supply logistics system 101 that may be used to allow a passenger to pre-order products from a dynamically generated product catalog in real-time based on available products at the departure location of the vehicle, to generate a vehicle service order, a packing inventory list, and an optimized loading plan based in part on the passenger-selected products, and to provide sufficient time for the caterer to physically load the products onto the vehicle. While the term “pre-order” may denote a passenger paying for one or more products to he delivered while in-transit, it is understood that “pre-order” may additionally include the term “pre-selecting” in which a passenger may select complimentary products offered by the carrier. Moreover, the passenger ordered products may alternatively delivered to a specified location (by address, airline lounge, hotel, etc.) before the departure of a vehicle, after the arrival of the vehicle, or even deliver digital goods (e.g., streaming video, e-books, digital music, etc.) which may be attached to an email address or provide a link via email address, text, etc.

The pre-order system 100 includes a pre-order engine 109 that is communicatively coupled to a product catalog database 121, to a historical transactions database 123, and to a number of pre-order clients 129 through a communication network 127. The pre-order engine 109 may be, for example, implemented in a server having a processor (not shown), a memory (not shown), a computer readable medium or storage unit (not shown) of any desired type or configuration. The memory may store the pre-order engine 109 that communicates with the pre-order clients 129. Each pre-order client 129 includes a processor (not shown) and a computer readable memory (not shown) that may execute a browser or any other application that may request to pre-order products for delivery during an in-transit trip. Any particular pre-order client 129 may be connected to or may be disposed, within a user interface device (not shown) that may be for example, a hand-held device, such as a smart phone or tablet computer, a mobile device, such as a mobile phone, a wearable mobile device, a computer, such as a laptop or a desktop computer, or any other device that allows a user to interface using the network 127. While only three pre-order clients 129 are illustrated in FIG. 1 to simplify and clarify the description, it is understood that any number of pre-order client 29 are supported and can he in communication with the pre-order engine 109.

A pre-order database 107 is connected to or is disposed within the pre-order engine 109 and may store passenger data, pre-order data, rules data, or any other data used in facilitating the pre-order of products. For example, passenger data may include the passenger's biographical information, itinerary (e.g., departing/origination location, arriving/destination location, flight/train/bus/cruise number, scheduled departure and arrival, etc.), preferences of the passenger including dietary restrictions, the passenger's financial information (e.g., credit card information), etc. The pre-order data may include passenger-placed pre-orders that may include the specific products ordered by a particular passenger for a specific trip. If an event occurs that requires a specific pre-order to be changed (e.g., inclement weather causes a flight to be delayed from early in the morning to early afternoon), the pre-order data may be automatically updated accordingly to reflect a pre-ordered lunch instead of the originally pre-ordered breakfast. The rules data may include any rules, restrictions, schema, etc. that are implemented to determine one or more dynamically generated product catalogs (described below), to automatically change or update a previously pre-ordered meal from breakfast to lunch based on the length of the delay, or to utilize historical transactions data to predict non-pre-ordered passengers' needs,

The product catalog database 121 is communicatively coupled to or may be disposed within the pre-order engine 109 and stores data relating to one or more product catalogs that may generated dynamically or manually by an operator. For example, the product catalog database 121 may include data relating to the current supply inventory at a particular departing/origination for layover) location, meal configuration data (i.e., the necessary ingredients, recipes, dishware, flatware, containers, equipment, etc. required for each meal), certified vendor/supplier data (i.e., only using supply inventory data from certified suppliers), carrier product preferences, or any other data relating to defining the products available to be delivered to a particular vehicle while in-transit. The historical transaction database 123 is also communicatively coupled to or may be disposed within the pre-order engine 109 and stores data relating to historical transactions performed by passengers. For instance, the historical transaction data may be used to predict meal preferences for a specific route, product placement or other marketing efforts, or any other type of predictive activities that may require historical transaction data.

The carrier supply logistics system 101 includes one or more servers 103 that are connected to carriers 150, suppliers 111, and vendors 115, some through a communication network 125. The supplier 111 stores a supply inventory database 113 that communicates with the pre-order engine 109 and operates to enable the pre-order engine 109 to retrieve up-to-the-minute supply inventory data from the particular supply inventory database 113. Despite FIG. 1 depicting only one supplier, any number of suppliers 111 may be employed in the system. The supply inventory database 113 is connected to or is disposed within a respective supplier server 111 and stores supply inventory data for one or more suppliers that includes data relating to the type, number, size, weight, volume, etc. of a particular product or item. Moreover, the supply inventory database 113 stores geographical location data together with each piece of inventory along with any other data relating to the particulars, regulations, rules, etc. of a particular airport, train station, bus station, port, etc. The supply inventory database 113 may also store data relating to the type of container that accompanies the product or item, whether the product is a carrier-specific product, the effective and expiration data range of a product, the cost of the item, etc.

A carrier-related database 105 is connected to or is disposed within a respective server 103 and stores earner-related data of any type, including for example, vehicle data (e.g., aircraft type and associated specifications, train car type and associated specifications, etc.) schedule data (e.g., departing and arriving times, ante information, airport information, delays, maintenance events, etc.), galley-related data (e.g., galley type, galley diagram, or any other galley-related information), etc. Generally speaking, the data stored in the carrier-related database 105 may be any data of any type and stored in any organizational manner including structured and unstructured data that may reside in relational and non-relational databases, or any other type of data residing in any other type of storage schema. Moreover, the carrier-related database may be maintained by only one carrier and contain data that solely pertains to that carrier. Alternatively, the server 103 may be maintained and supported by a third party feed service that provides up-to-the-minute schedule reporting by communicating with one or more carriers 150, airports, national scheduling databases, or any other source that provides the latest schedule or schedule changes.

The communication networks 125 and 127 may include, but are not limited to, any combination of a LAN, a MAN, a WAN, a mobile, a wired or wireless network, a private network, or a virtual private network. Moreover, while the communication networks 125 and 127 are illustrated separately in FIG. 1 to simplify and clarify the description, it is understood that only one network or more than two networks may be used to support communications with respect to the pre-order clients 129, the carriers 150, and vendor 115. Moreover, while only one vendor 115 is illustrated in FIG. 1, it is understood that any number of vendors 115 are supported and can be in communication with the pre-order engine 109. Vendors 115 may include caterers that prepare, package, load, etc. food and products in preparation for loading onto the vehicle for departure. For example, the caterer may receive a menu of one or more meals to be served on a departing vehicle, may prepare the food accordingly, and package the food into containers, onto carts, etc. Vendors 115 may additionally include lounge operators that prepare and serve food, drinks to passengers before departure and after arrival of a vehicle. Furthermore, a vendor 115 may include a delivery operator that delivers products to a passenger at a specific location (e.g., a hotel, a conference room, a residence, etc., before departure and after arrival of a vehicle, if the pre-ordered products are unable to be delivered while in-transit on the vehicle.

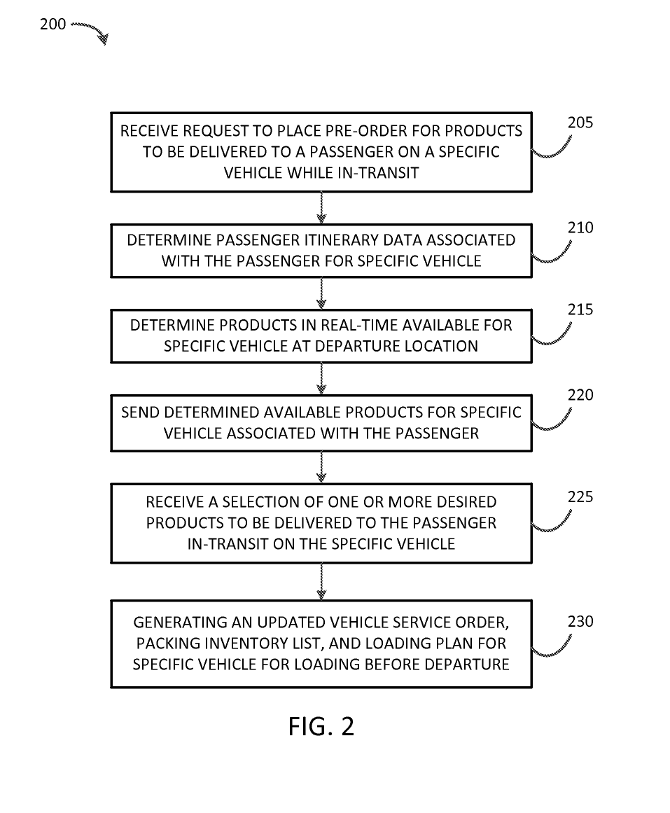

FIG. 2 illustrates a routine or a process flow diagram 200 that may be implemented by the pre-order engine 109 of FIG. 1 to receive a selection of pre-ordered products and generate a vehicle service order, an updated packing inventory list, and an optimized loading plan for a soon to be departing specific vehicle. At a block 205, the pre-order system 100 may receive a request to place a pre-order for products to be delivered to a passenger on a specific vehicle while in-transit. The request may be received from any number of entry points into the pre-order system 100. For example, a passenger may pre-order a meal on a soon-to-depart flight via a custom mobile application on a mobile device provided by the carrier or the pre-order engine 109, an airport kiosk, a website of the carrier or pre-order engine 109, or any other suitable means of placing a pre-order or pre-selection of products to be delivered to the passenger while in-transit.

At a block 210, the pre-order engine 109 may use metadata included in the request to determine passenger itinerary data associated with the passenger for the specific vehicle. The passenger itinerary data may include the passenger's name and biographical information, the passenger's itinerary (including a departure/origination location, one or more layover locations, and/or an arrival/destination location), or simply the confirmation code of the passenger's scheduled trip. If the departing location is not included in the passenger itinerary data, the pre-order engine 109 may use the one or more pieces of the passenger itinerary data to retrieve the departure location, specific vehicle, etc. associated with the particular itinerary of the passenger from the carrier-related database 105 via the communication network 125.

In any event, at a block 215, the pre-order engine 109 may determine, in real-time, one or products available for the passenger to pre-order for the specific vehicle on which the passenger will be departing. This determination of the pre-order engine 109 may performed in any number of manners. For example, the pre-order engine 109 may retrieve, from the supply inventory database 113, the current, real-time available supply inventory at the departing location associated with the passenger. Moreover in this example, the pre-order engine 109 may retrieve vehicle data, schedule data, and galley-related data associated with the passenger's itinerary from the carrier server 103. Continuing this example, the pre-order engine 109 may use predetermined (or dynamic) rules data in conjunction with retrieved supply inventory data, vehicle data, schedule data, and galley-related data to make the final determination of which one or more products to offer the passenger for pre-order.

For example, the pre-order engine 109 may use the number of passengers on a particular flight to determine the type or number of product offerings. If a flight is full, for example, stowage space may be extremely limited, and pre-order engine 109 may determine that duty-free products with a larger volume or mass may not be offered. Similarly, the pre-order engine 109 may use the demographics of the passengers on a particular vehicle to determine products offerings. For example, if the passengers on a flight includes a high school baseball team, the pre-order engine 109 takes this fact into account and determines a product, or meal offering that is more applicable to a large number of younger, athletic passengers. The pre-order engine 109, for that matter, may incorporate other passenger data, such as a passenger's main record, to determine product offerings. For example, a passenger main record may include an address, an age, etc., and the pre-order engine 109 may use passenger main record data to determine products tailored specifically to the age of the passenger, the likely income of the passenger based on the passenger's zip code, etc. The pre-order engine 109 may further use results from an analytics engine (not shown) to incorporate other factors (e.g., weather data, consumer trend data, a passenger's credit or debit card transactional data, public records, etc.) into the product offering determination.

Additionally, the pre-order engine 109 may retrieve pricing information associated with each determined item from the supply inventory database 113 and use the pricing information to determine a price along with the product offering. The pricing information may be based on a location of a product, a type of product, a particular airline, etc. Alternatively, the pre-order engine 109 may dynamically determine or adjust pricing based on any of the above mentioned variables, such as a vehicle data, schedule data, location data, etc.

As an example, a passenger may he flying with Carrier A in first class front Chicago to Zurich on a morning flight. In this example, because the passenger is set to depart the flight shortly, the pre-order engine 109 retrieves any necessary data from the supply inventory database 113 and the carrier-related database 105 in response to the passenger's request have a meal (or a duty-free watch product, etc.) be delivered while the passenger is in-transit or en route to Zurich. After retrieving this previously-mentioned data, the pre-order engine 109 may use the schedule data and rules data to determine that the particular flight departs in the morning from Chicago and requires a North American style breakfast (according to the predetermined rules data generally set by the carrier). Next, the pre-order engine 109 may utilize the supply inventory data to determine the supplies available at Chicago (i.e., the passenger's departing location), and using the rules data, may determine which items may be included as part of breakfast. Continuing this example, because the retrieved supply inventory data associated with Chicago indicates that eggs, butter, and bread are available, the pre-order engine 109 may offer at least an omelet and French toast as breakfast entrees to be delivered in-transit to the passenger. However, the pre-order engine 109 must also determine using the galley-related data whether stowage space, available stowage weight, and container space, etc. is available in the galley of this specific flight to Zurich. Moreover, the rules data may dictate that an oven or warming unit equipment is also required to serve an omelet, and as a result, the pre-order engine 109 must determine whether an omelet may be offered to the passenger based on the availability of space in galley stowage for the warming unit. As this example details, the pre-order engine 109 may utilize any number of considerations and pieces of data to determine, in real-time, the potential offerings for products to be delivered while the passenger is in transit. The pre-order engine 109 may determine entirely different menu options (based on the departure location, the time remaining prior to departure, the number of passengers booked, other passenger-related demographic data, the arrival location, and any other factors) to be delivered while in-transit to a passenger scheduled to depart on a flight.

For example, the pre-order engine 109 may utilized rules data in the pre-order database 107 to determine that a flight departing Chicago for Honolulu requires Hawaiian themed menu despite the flight departing out of Chicago. Moreover, in this example, the pre-order engine 109 may determine using the rules data that the available menu items must be restricted to “shelf stable” (i.e, non-perishable goods, products with a long shelf life, etc.) offerings because the flight is departing within four hours from the time of the meal request. For example, if a passenger requests to order a meal months or weeks out from the departure of the flight, the pre-order engine 109 may offer a much wider variety in choices for the passenger because sufficient time remains to order food from a supplier, prepare the food, package the food, etc. However, as time period from the pre-order request to the departure time shortens (i.e., a time decay function), the pre-order engine 109 may be able to offer a decreasing number of items because of the limited time remaining until departure.

Furthermore, in continuing this example, because the pre-order engine 109 determines that the flight includes a low passenger load (and thus fewer standard meals), the pre-order engine 109 may determine that galley has excess space for stowing larger number products. As a result, the pre-order engine 109, in this example, may determine that a larger number of pre-order products may offered to passengers interested in pre-ordering products to be delivered while in-transit. Additionally, idler determining that a large percentage of the passengers scheduled to take the flight includes foreign nationals, in this example, the pre-order engine 109 may determine that the standard loading regime must be changed because of the demographics of the passengers and that the entire menu of offered pre-order products, meals, etc. must be changed accordingly.

At a block 220, the pre-order engine 109 may send the determined one or more products to the passenger, and in return, receive a selection of one or more desired products (i.e., a subset of the determined products available) to be delivered while in-transit. The pre-order engine 109 may store this selection of one or more desired products in the pre-order database 107 as a pre-order associated with passenger. Furthermore, the pre-order engine 109, at a block 230, may determine the items, ingredients, etc. associated with the selected one or more desired products and communicate with the supplier(s) to confirm order of the necessary items. Moreover, the pre-order engine 109 may generate, a vehicle service order, an updated packing inventory list, and a loading plan for the specific vehicle associated with the passenger's itinerary and transmit the updated vehicle service order to the supplier 111, the updated packing inventory list and updated loading plan to the vendor 115 for loading the specific vehicle before departure. Beneficially, this configuration of the pre-order system 100 allows the pre-order engine 109 to efficiently and quickly determine available products to be delivered while in-transit based on supply inventory data, schedule data, vehicle data, galley-related data, rules data, and any other suitable data, so that a passenger may pre-order one or more available products shortly before the departure of the vehicle.

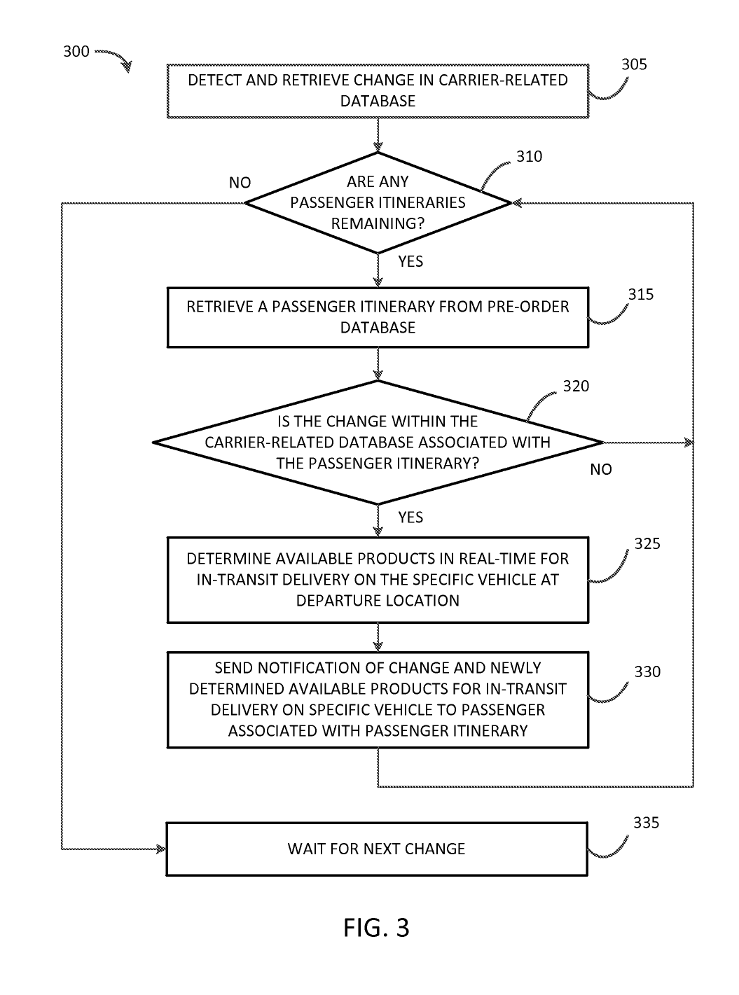

FIG. 3 illustrates a routine or process flow diagram 300 that may be implemented by the pre-order engine 109 to detect and send an electronic alert notifications based on pre-orders stored in the pre-order database 107 (block 305). Generally, the carrier server 103 detects and retrieves changes from the carrier-related database 105, and then analyzes stored pre-orders within the pre-order database 107 to determine whether a detected change affects the products ordered as specified by the one or more stored pre-orders in the pre-order database 107, if so, the pre-order engine 109 may send an electronic notification of the change to the passenger, via the pre-order client 129, that allows the passenger to change (or cancel) her pre-ordered products if desired, in particular, at a block 305, the pre-order engine 107 retrieves a change in data from the carrier-related database 105. Generally speaking, a change occurs when any modification is made to any data contained in a carrier-database 105, including any of the schedule data (e.g., a delay, canceled route, etc.), the vehicle data (e.g., vehicle switch that includes a different galley because of maintenance issues, mechanical failure, a load or balance problem, etc.), the galley-related data, etc. The data change may also include a seat change for the passenger (e.g., a passenger upgrades to first class and is entitled to an entirely different menu) or a database-wide automatic change of the supply inventory database 113 because of seasonal changes. A data change may be one that adds data, deletes data, or changes existing data within the carrier-related database 105. Additionally or alternatively, changes in the supply inventory database 113 may also be detected and communicated to the pre-order engine 109. For example, if a particular item is no longer available for whatever reason, the supplier server 111 may make the pre-order engine 109 aware of the change.

Alternatively, the pre-order engine 109 may poll the carrier-related database 105 to detect changes in the carrier-related database 105. The block 305 may detect a change to the carrier-related database 105 by continually polling a change queue maintained by the server 103 to determine whether a change has occurred. This change queue may be stored on the server 103 or in the carrier-related database 105 and may log a record for each change that occurs in the carrier-related database 105. If desired, the change queue may store a pointer to point to the piece of data for each change a the carrier-related database 105. The routine 305, in using the pointer information in the change queue, may retrieve the specific data that changed and all associated data from the carrier-related database 105.

In any event, after the block 305 detects and retrieves the data associated with the change from the carrier-related database 105, a block 310 operates to determine whether any stored pre-orders (including or based on the passenger itinerary) reside in the pre-order database 107. If so, the block 310 transfers control to a block 315 to retrieve a stored pre-order. If not, the block 310 transfers control to a block 335 that waits for the next change to occur.

A block 315 operates to retrieve a stored pre-order (including the passenger itinerary) from the pre-order database 107. The stored pre-order includes the passenger itinerary data, the products pre-ordered, etc. At a block 320, the pre-order engine 109 determines whether the retrieved passenger itinerary associated with the data change within the carrier-related database 105 is associated with passenger itinerary identified by the stored pre-order. In implementing this method, if the block 320 determines that change within the carrier-related database 105 is associated with the retrieved passenger itinerary, then the method transfers control to the block 325 to determine available products in real-time. Furthermore, the block 320 may determine if a changed occurred within any other databases, for example, a new product offering may be reflected as a change within the supply inventory database 113 of one of the suppliers 111, and the new product offering may be propagated “upstream” throughout the system. On the other hand, if the block 320 determines that the change is not associated with the retrieved passenger itinerary, the block 320 transfers control back to the block 310 to determine whether another stored pre-order and associated passenger itinerary is present in the pre-order database 107.

At a block 325, the pre-order engine 109 determines again (in a similar manner to the block 215 of FIG. 2) the available products at the departure location, in real-time, to be delivered in-transit on the specific vehicle. Because the supply inventory, schedule, vehicle, etc. may have changed, the pre-order engine 109 must determine the available products to be delivered in-transit again. After determining the new set of available products, the pre-order engine 109, at a block 330, may send a notification to the passenger (by email, text, mobile application via the pre-order client, by phone call, etc.) that informs the passenger of the change and the type of change. At the block 330, the pre-order engine 109 may, additionally or alternatively, provide the newly determined available products to be delivered while in-transit to the passenger. Moreover, the notification that includes the newly determined products may suggest that the passenger update her pre-order because the products no longer are available, etc. After the block 330 sends the notification, the pre-order engine 109 may determine if any other stored pre-orders and associated passenger itineraries remain in the pre-order database 107 at the block 310.

As an alternative implementation, the we-order engine 109 may automatically change or adjust a passenger's pre-order. For example, if a six hour delay of a morning flight is detected by the carrier server 103 and propagates this delay information to the pre-order engine 109, the pre-order engine 109 may automatically change the passenger's pre-ordered breakfast into a pre-ordered lunch.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across it number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical electronic, magnetic, or optical) quantities within one or more memories (e g., volatile memory, non-volatile memory, or a combination thereof), registers, or other machine components that receive, store, transmit, or display information.

Still further, the figures depict preferred embodiments of a pre-order system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for generating, in real-time, a vehicle service order, an updated packing inventory list, and a loading plan through the disclosed principles herein. Thus, while particular embodiments and applications have been illustrated and described, it is to be understood that the disclosed embodiments arc not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for automatically generating, in real-time and based on a pre-order of products, an updated optimized vehicle service order associated with a specific vehicle, the vehicle service order including at least a particular set of products to be loaded onto the specific vehicle before departure, the method comprising:
receiving, via a digital communication network, a request for a passenger to pre-order one or more products before the departure of a specific vehicle, wherein i) the passenger is scheduled to depart on the specific vehicle, ii) the one or more products are to be delivered in-transit to the passenger after the departure of the specific vehicle, and iii) the passenger is associated with passenger itinerary data that includes at least a departure location of the specific vehicle;
determining, using the passenger itinerary data, products available for in-transit delivery based on a real-time supply inventory of items physically available at the departure location associated with the passenger itinerary data, the supply inventory including items supplied by one or more suppliers;
transmitting, via the digital communication network, the determined products available for in-transit delivery on the specific vehicle;
receiving, via the digital communication network, a selection of one or more desired products to be delivered in-transit to the passenger after departure of the specific vehicle, the selection of the one or more desired products being a subset of the available products; and
generating, in real-time and using the received selection of the one or more desired products, an updated vehicle service order for the specific vehicle that includes at least the selection of the received selection of the one or more desired products.

2. The method of claim 1, further comprising:
detecting a change for schedule data within a carrier-related database;
determining whether the change in schedule data within the carrier-related database is associated with the passenger itinerary data of the passenger; and
in response to the determination that the passenger itinerary data of the passenger is associated with the change in schedule data, transmitting to the passenger an electronic alert notification that indicates that the selection of one or more desired products of the passenger is no longer valid.

3. The method of claim 2, further comprising:
receiving an change request from the passenger to change the selection of one or more desired products;
determining, using the passenger itinerary data, an updated list of products available for in-transit delivery based on the real-time supply inventory of items physically available at the departure location associated with the passenger itinerary data, the supply inventory including items supplied by the one or more suppliers; and
transmitting to the passenger the updated list of determined products available for in-transit delivery on the specific vehicle.

4. The method of claim 1, wherein determining products available in-transit further includes determining products available in-transit based on vehicle specifications of the specific vehicle associated with the passenger itinerary data of the passenger.

5. The method of claim 2, wherein generating the updated vehicle service order for the specific vehicle includes further generating at least of an updated packing inventory list or an updated loading diagram according to the vehicle specifications of the specific vehicle.

6. The method of claim 1, wherein determining products available in-transit further includes determining products available based on the availability of one or more vendors stationed at the departure location.

7. The method of claim 1, wherein determining products available in-transit further includes determining products available based on a meal requirement, wherein at least one product is a meal and the meal requirement includes a list of related items required to serve the meal.

8. The method of claim 7, wherein the related items associated with the meal requirement include at least one of ingredients, dishware, containers, or equipment needed to properly serve the meal.

9. The method of claim 1, furthering comprising:
transmitting the selection of the one or more products and associated passenger data to the onboard system of the specific vehicle.

10. The method of claim 1, further comprising:
physically loading products associated with the vehicle service order onto the specific vehicle before departure.

11. A computer-readable medium having instructions stored thereon and executable by one or more processors to perform a method of automatically generating, in real-time and based on a pre-order of products, an updated optimized vehicle service order associated with a specific vehicle, the vehicle service order including at least a particular set of products to be loaded onto the specific vehicle before departure, the method comprising:
receiving, via a digital communication network, a request for a passenger to pre-order one or more products before the departure of a specific vehicle, wherein i) the passenger is scheduled to depart on the specific vehicle, ii) the one or more products are to be delivered in-transit to the passenger after the departure of the specific vehicle, and iii) the passenger is associated with passenger itinerary data that includes at least a departure location of the specific vehicle;
determining, using the passenger itinerary data, products available for in-transit delivery based on a real-time supply inventory of items physically available at the departure location associated with the passenger itinerary data the supply inventory including items supplied by one or more suppliers;
transmitting, via the digital communication network, the determined products available for in-transit delivery on the specific vehicle;
receiving, via the digital communication network, a selection of one or more desired products to be delivered in-transit to the passenger after departure of the specific vehicle, the selection of the one or more desired products being a subset of the available products; and
generating, in real-time and using the received selection of the one or more desired products, an updated vehicle service order for the specific vehicle that includes at least the selection of the received selection of the one or more desired products,

12. The computer readable medium of claim 11, the method further comprising:
detecting a change for schedule data within a carrier-related database;
determining whether the change in schedule data within the carrier-related database is associated with the passenger itinerary data of the passenger; and
in response to the determination that the passenger itinerary data of the passenger is associated with the change in schedule data, transmitting to the passenger an electronic alert notification that indicates that the selection of one or more desired products of the passenger is no longer valid.

13. The computer readable medium of claim 12, the method further comprising:
receiving an change request from the passenger to change the selection of one or more desired products;
determining, using the passenger itinerary data, an updated list of products available for M-transit delivery based on the real-time supply inventory of items physically available at the departure location associated with the passenger itinerary data, the supply inventory including items supplied by the one or more suppliers; and
transmitting to the passenger the updated list of determined products available for in-transit delivery on the specific vehicle.

14. The computer readable medium of claim 11, wherein determining products available in-transit further includes determining products available in-transit based on vehicle specifications of the specific vehicle associated with the passenger itinerary data of the passenger.

15. The computer readable medium of claim 14, wherein generating the updated packing inventory list for the specific vehicle includes further generating at least of an updated vehicle service order or an updated loading diagram according to the vehicle specifications of the specific vehicle.

16. The computer readable medium of claim 11, wherein determining products available in-transit further includes determining products available based on the availability of one or more caterers stationed at the departure location.

17. The computer readable medium of claim 11, wherein determining products available in-transit further includes determining products available based on a meal requirement, wherein at least one product is a meal and the meal requirement includes a list of related items required to serve the meal.

18. The computer readable medium of claim 15, wherein the related items associated with the meal requirement include at least one of ingredients, dishware, containers, or equipment heeded to properly serve the meal.

19. The computer readable medium of claim 11, wherein the method further comprises:
physically loading products associated with the vehicle service order onto the specific vehicle before departure.

20. A system for automatically generating, in real-time and based on a pre-order of products, an updated optimized vehicle service order associated with a specific vehicle, the vehicle service order including at least a particular set of products to be loaded onto the specific vehicle before departure comprising:
pre-order engine configured to:
receiving, via a digital communication network, a request for a passenger to pre-order one or more products before the departure of a specific vehicle, wherein i) the passenger is scheduled to depart on the specific vehicle, ii) the one or more products are to be delivered in-transit to the passenger after the departure of the specific vehicle, and iii) the passenger is associated with passenger itinerary data that includes at least a departure location of the specific vehicle;
determining, using the passenger itinerary data, products available for in-transit delivery based on a real-time supply inventory of items physically available at the departure location associated with the passenger itinerary data, the supply inventory including items supplied by one or more suppliers;
transmitting, via the digital communication network, the determined products available for in-transit delivery on the specific vehicle;
receiving, via the digital communication network, a selection of one or more desired products to be delivered in-transit to the passenger after departure of the specific vehicle, the selection of the one or more desired products being a subset of the available products; and
generating, in real-time and using the received selection of the one or more desired products, an updated vehicle service order for the specific vehicle that includes at least the selection of the received selection of the one or more desired products.
